(19) United States
(12) Patent Application Publication
(10) Pub. No.: US 2026/0036461 A1
(43) Pub. Date: Feb. 5, 2026

(54) Method and Apparatus for Measuring Remaining Amount of Liquid in Liquid Storage Container

(71) Applicant: LG Energy Solution, Ltd., Seoul (KR)

(72) Inventor: Jae Chan Lee, Daejeon (KR)

(73) Assignee: LG Energy Solution, Ltd., Seoul (KR)

(21) Appl. No.: 19/099,135

(22) PCT Filed: Jul. 10, 2023
(86) PCT No.: PCT/KR2023/009764

§ 371 Date: Jan. 28, 2025

(30) Foreign Application Priority Data
Aug. 1, 2022 (KR) 10-2022-0095708

(51) Int. Cl. G01F 23/292; G01N 15/00; G01N 15/0227; G06N 20/00

(52) U.S. Cl. CPC G01F 23/2921; G01N 15/0227; G06N 20/00; G01N 2015/0011

(57) ABSTRACT

A method for measuring a remaining amount of a liquid within a liquid storage container includes: discharging the liquid within the liquid storage container to outside through a suction tube, observing a size or a number of bubbles contained in the liquid passing through a light transmitting part; and estimating the remaining amount of liquid based on the size and number of observed bubbles. Furthermore, the method may further include estimating the remaining amount using an ultrasonic carrier wave, wherein the estimating of the remaining amount using the ultrasonic carrier wave may include: oscillating ultrasonic waves from an ultrasonic generator to the inside of the liquid storage container; receiving the ultrasonic waves returned after the oscillation to analyze a waveform of the ultrasonic waves; and comparing the waveform of the ultrasonic waves to previously provided reference data to estimate the remaining amount of liquid.

### CROSS-REFERENCE TO RELATED APPLICATIONS

The present application is a national phase entry under 35 U.S.C. § 371 of International Application No. PCT/KR2023/009764 filed Jul. 10, 2023, which claims priority to Korean Patent Application No. 10-2022-0095708, filed on Aug. 1, 2022, the disclosures of which are hereby incorporated by reference in their entirety.

### TECHNICAL FIELD

The present disclosure relates to a method and apparatus for measuring a remaining amount of liquid in a liquid storage container, and more particularly, to a method and apparatus for measuring a remaining amount of liquid in a liquid storage container capable of more accurately and quickly estimating and identifying the remaining amount of liquid in the liquid storage container that is difficult to visually check the inside thereof.

### BACKGROUND

Secondary batteries, which are widely used in various digital devices and transport means such as vehicles are repeatedly chargeable and dischargeable. Research and development are continuously performed to increase efficiency and improve safety of such secondary batteries.

A secondary battery is manufactured by accommodating an electrode assembly, in which a positive electrode/separator/negative electrode are repeatedly stacked, in a case, such as a can or pouch, and then, injecting an electrolyte into the case.

The electrolyte is injected into a liquid storage In container such as a drum and then is moved and stored. addition, as shown in FIG. 1, which illustrates a cross-sectional view of an electrolyte being discharged from a liquid storage container, the liquid storage container 1 is provided in a cylindrical shape having a bottom surface 1a, a circumferential wall 1b, and a top surface 1c, and in a state of standing vertically, when a suction tube 3 enters through a hole defined in the top surface 1c, and a negative pressure is applied to the suction tube 3, an electrolyte L is discharged to the outside of the liquid storage container 1.

However, in order to maintain physical and chemical stability of the electrolyte L, the liquid storage container 1 in which the electrolyte is stored is made of stainless steel. Thus, there is a problem in that it is difficult to visually check a remaining amount of electrolyte inside the liquid storage container, i.e., a height of a water surface S, from the outside.

In the related art, an internal pressure of the liquid storage container 1 increases to inject an inert gas g into the liquid storage container 1 through a gas injection tube 2 during discharging of the electrolyte or when the discharge of the electrolyte is almost finished so as to minimize a remaining amount of electrolyte.

However, an injection of a gas g may start when the water surface S of the electrolyte L falls below a certain reference, and when the water surface S of the electrolyte falls below the suction tube 3, it is preferable that the injection of the gas g is stopped, but when a time point at which the injection of the gas g starts is too early, and a time point at which the injection g of the gas is stopped is too late, there is a problem in that bubbles P (see FIG. 2) are introduced together into the suction tube 3.

In addition, when the electrolyte is injected into the case of the secondary battery (such as measuring an amount of electrolyte injection), the bubbles cause defects of the secondary battery. That is, when a small amount of electrolyte remains, the gas g is injected into the liquid storage container to ensure smooth discharge of the electrolyte, but when the gas g is introduced into the suction tube 3, which injects the electrolyte into the case of the secondary battery, a motor or pump, which generates the negative pressure in the suction may idle thereby causing malfunction.

Furthermore, when the gas g introduced together with the electrolyte is introduced into the case of the secondary battery, a swelling phenomenon occurs in the secondary battery in the future.

Thus, in order to prevent the inflow of the bubbles P and waste of the electrolyte, a technical need is required for measuring the remaining amount in the liquid storage container 1 in which the electrolyte is stored.

### TECHNICAL PROBLEM

A main object of the present disclosure is to provide a method and apparatus for measuring a remaining amount of liquid within a liquid storage container capable of quickly and accurately estimating or measuring the remaining amount of electrolyte within the liquid storage container to satisfy the above technical needs. For reference, the ‘measurement’ described here is used not only to measure the remaining amount of electrolyte (liquid), but also to predict and estimate how much electrolyte remains in the liquid storage container or whether the remaining amount has fallen below a predetermined standard value.

### TECHNICAL SOLUTION

The present disclosure for achieving the above-mentioned object includes a method and apparatus for measuring a remaining amount of liquid in a liquid storage container. In addition, the present disclosure provides a configuration for estimating (predicting or measuring) the remaining amount by monitoring bubbles contained in the discharged liquid (electrolyte) and provides an additional configuration capable of being accomplished together with or separately from the above configuration, i.e., a configuration that oscillates ultrasonic waves inside the liquid storage container to estimate (predict or measure) the remaining amount based on the waveform of the ultrasonic carrier wave.

Among them, in the measuring method and measuring apparatus that monitor the bubbles contained in the discharged electrolyte to estimate the remaining amount, a light transmitting part is provided in the suction tube to observe characteristics of the bubbles through the light transmitting part and estimate the remaining amount of electrolyte based on the observed characteristics, and in the present disclosure, the measuring method and measuring apparatus having these technical features are provided as examples.

That is, a method for measuring a remaining amount of a liquid within a liquid storage container, which is provided in this embodiment, includes: discharging the liquid within the liquid storage container to the outside through a suction tube inserted into the liquid storage container; observing a size of a bubble or the number of bubbles contained in the liquid passing through the light transmitting part through a vision device that emits light toward the light transmitting part of the suction tube; and estimating the remaining amount of liquid based on the size and number of observed bubbles.

In addition, the method may further include injecting a gas into the liquid storage container after discharging the liquid within a predetermined range.

The liquid may be an electrolyte for a secondary battery, and the gas injected into the liquid storage container may be nitrogen.

The method may further include, when it is estimated that the estimated remaining amount of liquid is less than a predetermined remaining amount, stopping the injection of the gas into the liquid storage container.

In the observing of the size of the bubble or the number of bubbles, light may be emitted from the lighting toward the light transmitting part.

A controller configured to estimate the remaining amount of liquid based on information received from the vision device may estimate the remaining amount of liquid in a machine learning manner in which a correlation between the size and number of observed bubbles and an actual amount of liquid remaining is learned to estimate the remaining amount based on the learned data.

In addition, the controller configured to estimate the remaining amount of liquid based on information received from the vision device may compare the size and number of observed bubbles to previously provided reference data to estimate the remaining amount of liquid.

Furthermore, the method may further include estimating the remaining amount using an ultrasonic carrier wave. The estimating of the remaining amount using the ultrasonic carrier wave may include: oscillating ultrasonic waves from an ultrasonic generator to the inside of the liquid storage container; receiving the ultrasonic waves returned after the oscillation to analyze a waveform of the ultrasonic waves; and comparing the waveform of the ultrasonic waves to previously provided reference data to estimate the remaining amount of liquid.

The ultrasonic generator may be in close contact with a center of an outer surface of the bottom of the liquid storage container or be in close contact with a circumferential wall of the liquid storage container.

The estimating of the remaining amount using the ultrasonic carrier wave may be performed before the discharging of the liquid within the liquid storage container to the outside through the suction tube or after the estimating of the remaining amount of liquid through the size and number of observed bubbles.

Furthermore, the present disclosure provides a measuring apparatus capable of measuring a remaining amount by determining a state of bubbles as described above.

An apparatus for measuring a remaining amount of liquid within a liquid storage container, which is provided in the present disclosure, includes: a liquid storage container in which a liquid is stored; a suction tube which is connected to the liquid storage container, through which the liquid is suctioned and discharged, and which is provided with a light transmitting part made of a transparent or translucent material; a vision device directed to the light transmitting part; and a controller configured to receive information about a size and number of bubbles from the vision device so as to estimate the remaining amount of liquid.

The controller may be configured to output the information on the size and number of bubbles, which is received from the vision device, and the estimation results on a display device.

The apparatus may further include a lighting configured to emit light toward the light transmitting part.

The light transmitting part may be disposed in a predetermined section in the suction tube and be disposed in a section extending in a straight line from the outside the liquid storage container.

Furthermore, the present disclosure provides a measuring method and apparatus in which ultrasonic waves are oscillated to estimate a remaining amount based on a waveform of an ultrasonic carrier wave.

A method for measuring a remaining amount of liquid within a liquid storage container includes: closely attaching an ultrasonic generator generating ultrasonic waves to an outer surface of the liquid storage container; oscillating the ultrasonic waves from the ultrasonic generator to the inside of the liquid storage container; receiving the ultrasonic waves returned after the oscillation to analyze a waveform of the ultrasonic waves; and comparing the waveform of the ultrasonic waves to previously provided reference data to estimate the remaining amount of liquid.

In addition, the present disclosure provides an apparatus for measuring a remaining amount of liquid in a liquid storage container to which the above-described method for measuring the remaining amount is applied. An apparatus for measuring a remaining amount of liquid within the liquid storage container includes: a liquid storage container in which a liquid is stored; an ultrasonic generator attached to an outer surface of the liquid storage container to oscillate ultrasonic waves toward the inside of the liquid storage container; an ultrasonic receiver configured to receive the ultrasonic waves returned after being generated from the ultrasonic generator; and a controller configured to estimate the remaining amount of liquid by comparing waveform information of the ultrasonic waves received from the ultrasonic receiver to previously provided reference data.

The ultrasonic receiver may be integrated with the ultrasonic generator, and the ultrasonic generator may be configured to oscillate the ultrasonic waves, receive the returned ultrasonic waves, and transmit waveform information of the received ultrasonic waves to the controller.

The ultrasonic generator may be attached to a center of an outer surface of the bottom of the liquid storage container or be attached to a circumferential wall of the liquid storage container.

### ADVANTAGEOUS EFFECTS

The present disclosure having the above configuration may determine the remaining amount of liquid (electrolyte) in the liquid storage container in real time, and thus, the input and stop time points and an input amount of gas injected into the liquid storage container may be more accurately determined to solve the conventional problem in which the motor and the pump malfunction, and the bubbles are introduced together into the case of the secondary battery.

According to the present disclosure, the remaining amount may be estimated by observing the size and number of bubbles passing through the suction tube so as not to affect the flow speed of the electrolyte and not to cause the physical and/or chemical changes or impacts to the electrolyte. In addition, since there is no need for separate measuring equipment to be introduced into the liquid storage container, the inflow of the foreign substances may be blocked fundamentally.

When observing the bubbles at the light transmitting part, the additional light may be irradiated from the lighting to observe the size and number of bubbles through the more accurate image data.

In the present disclosure, the controller may more quickly estimate the remaining amount of liquid by comparing the size and number of observed bubbles to the previously provided reference data.

Alternatively, the controller may estimate the remaining amount of liquid using the machine learning method that learns by comparing and analyzing the correlation between the size and number of observed bubbles and the actual remaining amount of liquid and estimates the remaining amount of liquid based on the learned data, and thus, even when the physical properties are changed, or the size of the liquid storage container is changed, the remaining amount of liquid may be estimated in consideration of the variables.

Furthermore, in the present disclosure, the remaining amount of electrolyte may be estimated using the ultrasonic carrier wave. Therefore, the remaining amount of electrolyte may be more accurately measured by performing the method for estimating the remaining amount by observing the bubbles.

### BRIEF DESCRIPTION OF THE DRAWINGS

FIG. 1 is a cross-sectional view illustrating a state in which an electrolyte is discharged from a liquid storage container.

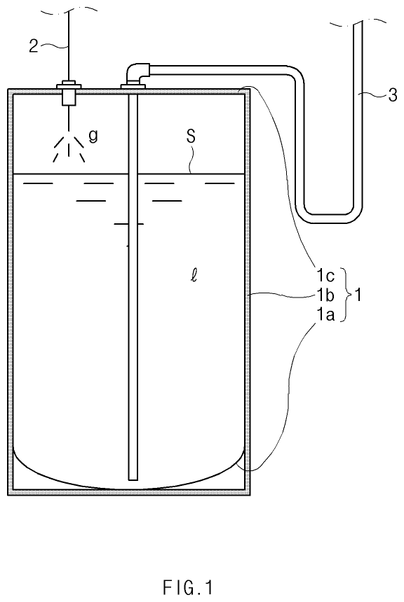

FIG. 2 is a view illustrating a state in which a vision device and a lighting are disposed to observe a size and number of bubbles through a light transmitting part of a suction tube, and the vision device is connected to a controller.

FIG. 3 is a view illustrating a state in which an ultrasonic generator is attached to an outer bottom surface of a liquid storage container and is connected to a controller.

FIG. 4 is a view illustrating a state in which the ultrasonic generator is attached to an outer circumferential wall of the liquid storage container and is connected to the controller.

FIG. 5 is a view illustrating a state in which a vision device and a lighting are disposed to observe a size and number of bubbles through a light transmitting part of a suction tube, the ultrasonic generator is attached to an outer circumferential surface of the liquid storage container, and each of the vision device and the ultrasonic generator is connected to the same one controller.

### DETAILED DESCRIPTION

Hereinafter, preferred embodiments of the present disclosure will be described in detail with reference to the accompanying drawings in such a manner that the technical idea of the present disclosure may easily be carried out by a person with ordinary skill in the art to which the disclosure pertains. The present disclosure may, however, be embodied in different forms and should not be construed as limited to the embodiments set forth herein.

In order to clearly describe the present disclosure, parts irrelevant to the description are omitted, and the same reference numerals are assigned to the same or similar components throughout the specification.

Also, terms or words used in this specification and claims should not be restrictively interpreted as ordinary meanings or dictionary-based meanings, but should be interpreted as meanings and concepts conforming to the scope of the present disclosure on the basis of the principle that an inventor can properly define the concept of a term to describe and explain his or her disclosure in the best ways.

The present disclosure relates to a method and apparatus for measuring a remaining amount of electrolyte L in a liquid storage container 10.

The present disclosure provides a configuration for estimating a remaining amount by monitoring bubbles P contained in a discharged liquid electrolyte as a first embodiment and provides an additional configuration that is performed together with the first embodiment or performed separately from the first embodiment, i.e., a configuration that oscillates ultrasonic waves into a liquid storage container and estimates the remaining amount based on the waveform of the ultrasonic carrier wave a as second embodiment. Hereinafter, embodiments will be described in more detail with reference to the accompanying drawings.

### First Embodiment

The present disclosure provides a method and apparatus for estimating a remaining amount by monitoring bubbles P contained in a discharged electrolyte L as a first embodiment.

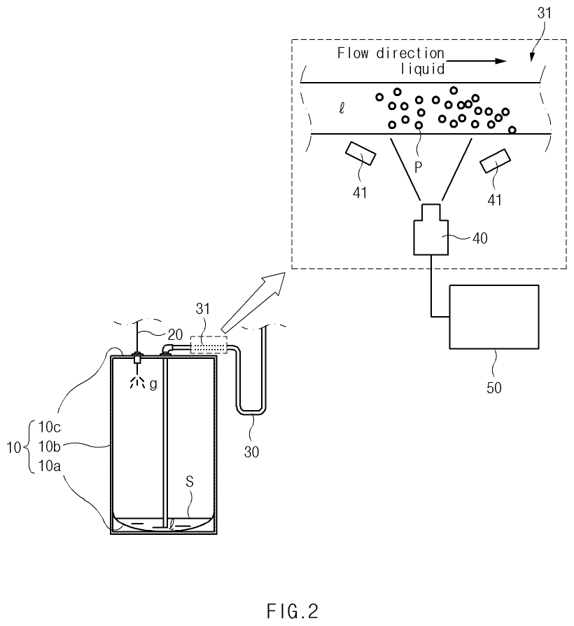

FIG. 2 is a view illustrating a state in which a vision device 40 and a lighting 41 are disposed to observe a size and number of bubbles P through a light transmitting part 31 of a suction tube 30, and the vision device 40 is connected to a controller 50.

Referring to FIG. 2, an apparatus for measuring a remaining amount of a liquid in a liquid storage container provided in this embodiment includes a liquid storage container 10 in which a liquid is stored, a suction tube 30, a vision device 40, and a controller 50.

The liquid storage container 10 has a cylindrical shape with a bottom surface 10a, a circumferential wall 10b standing vertically along a circumference of the bottom surface 10a, and a top surface 10c covering an opened upper side of the circumferential wall 10b. In addition, at least two holes are punched in the top surface 10c, and a gas injection tube 20 through which a gas g is injected into the liquid storage container and a suction tube 30 through which an electrolyte is suctioned from the liquid storage container 10 and then is discharged to the outside are coupled to the holes, respectively.

The gas injection tube 20 does not protrude into the liquid storage container 10 or protrudes only by a small length, but the suction tube 30 has an end disposed close to the bottom surface 10a to maximize suction of the electrolyte stored in the liquid storage container 10.

The bottom surface 10a may be provided as a spherical surface, and the end of the suction tube 30 may be disposed as low as possible at a slight distance from a center of the spherical surface.

As described above, one side of the suction tube 30 is placed on the bottom surface 10a inside the liquid storage container 10, and the other side of the suction tube 30 is connected to a separate storage facility or an injection device for injecting the electrolyte to suction the electrolyte L stored in the liquid storage container 10 and then allow the electrolyte L to move to the storage facility or the injection device.

The suction tube 30 is provided with a light transmitting part 31 made of a transparent or translucent material (preferably made of a transparent material) at a portion that is spaced apart from the liquid storage container 10 so as to be exposed to the outside.

The light transmitting part 31 may be disposed in a predetermined section of the suction tube 30 or may be disposed not only at one position but at two or more positions spaced apart from each other. In addition, the position is not particularly limited, but is disposed in a section extending in a straight line from the outside the liquid storage container 10 so that more accurate optical information is obtained when the vision device 40 optically senses the bubbles P.

The vision device 40 may use a camera, an optical sensor, and the like, which are capable of obtaining an optical image or an image having the number and/or size of bubbles P contained in the electrolyte to move together while the electrolyte moves.

The vision device 40 transmits the acquired image information to the controller 50. In addition, the lighting 41 that emits light toward the light transmitting part 31 may be added according to lighting conditions around the light transmitting part 31.

The image information about the size and number of bubbles P from the vision device 40 is transmitted to the controller 50, and then, the controller 50 analyzes the received image information to estimate a remaining amount of electrolyte inside the liquid storage container 10 or a height of a water surface S of the electrolyte. That is, when the water surface S of the electrolyte L falls below the end of the suction tube 30, air and gas g together with the electrolyte are suctioned into the suction tube 30. Here, the air and gas g pass through the light transmitting part 31 in the form of bubbles P while the electrolyte flows. Thus, the height of the water surface S of the electrolyte may be estimated through the size and number of bubbles P, and thus, the remaining amount may also be estimated.

Therefore, the measuring apparatus has a configuration, in which a portion of the suction tube 30 is transparent to provide the light transmitting part 31, and the state of the bubbles P is determined through the light transmitting part 31 to estimate the remaining amount. For reference, when the size of each of the bubbles P is small, sensing performance may be improved by additionally irradiating the lighting 41 or increasing in resolution of the captured image.

The controller 50 may be configured to output the information on the size and number of bubbles, which is received from the vision device 40, and may display the estimation results on a display device (not shown) so that a worker and/or manager may determine the remaining amount of liquid.

Furthermore, the controller 50 may be configured to compare the size and number of observed bubbles to previously provided reference data so as to estimate the remaining amount of liquid (electrolyte). Alternatively, the controller may be configured to estimate the remaining amount of liquid in a learning machine manner in which the correlation between the size and number of observed bubbles and an actual remaining amount of liquid is compared and analyzed to be learned, and then, the remaining amount is estimated based on the learned data.

This embodiment provides a measuring method using the measuring apparatus having the above configuration.

A method for measuring the remaining amount of liquid in the liquid storage container 10 provided in this embodiment begins with a process of discharging an electrolyte stored in a liquid storage container to the outside through a suction tube 30.

As described above, a light transmitting part 31 is provided on the suction tube 30 so that a vision device 40 performs a process of observing (sensing) a size of bubble P or the number of bubbles P, which are contained in the electrolyte passing through the light transmitting part 31.

Then, a process of estimating the remaining amount of liquid based on the size and number of observed bubbles through a controller 50 receiving image data from the vision device 40 is performed.

Furthermore, a process of injecting a gas g into the liquid storage container after discharging the liquid within a predetermined range according to the remaining amount, i.e., the number of bubbles, may be additionally performed. Here, as described above, the liquid is an electrolyte for a secondary battery, and the gas injected into the liquid storage container is nitrogen, which does not chemically react with the electrolyte.

In addition, when the remaining amount of liquid is estimated to be lower than a predetermined remaining amount, a process of stopping the gas injection into the liquid storage container is performed.

### Second Embodiment

Furthermore, the present disclosure provides a measuring method and apparatus in which ultrasonic waves are oscillated to estimate a remaining amount based on a waveform of an ultrasonic carrier wave as a second embodiment. The method using the ultrasonic carrier wave according to the second embodiment may be performed simultaneously with the measuring method according to the first embodiment or performed separately before and after the measuring method according to the first embodiment or performed instead of the measuring method according to the first embodiment.

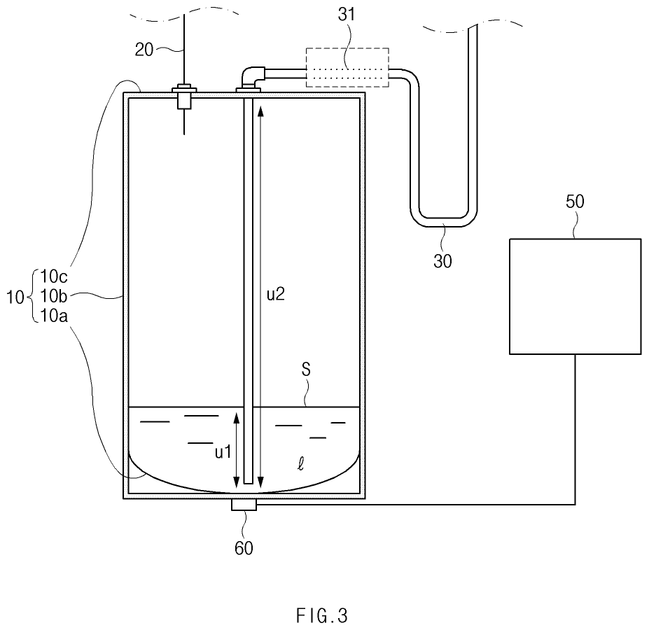

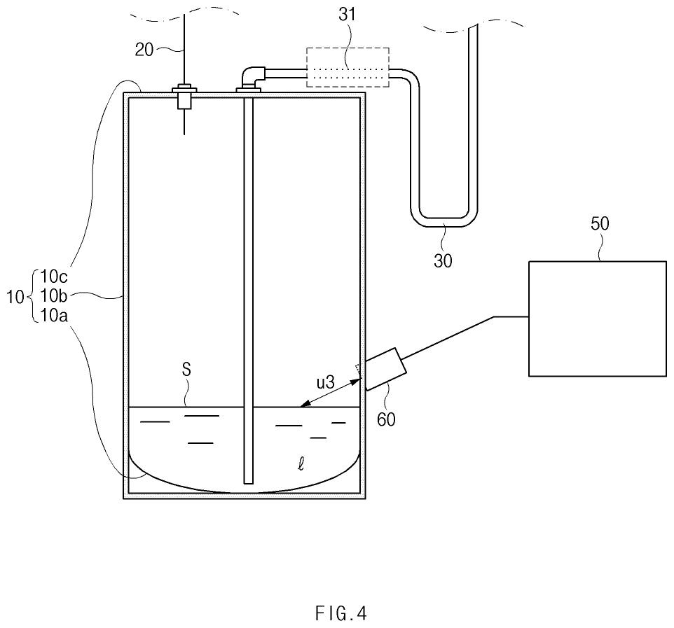

FIG. 3 is a view illustrating a state in which an ultrasonic generator 60 is attached to an outer bottom surface 10a of the liquid storage container and is connected to the controller 50, and FIG. 4 is a view illustrating a state in which the ultrasonic generator 60 is attached to an outer circumferential wall 10b of the liquid storage container and is connected to the controller.

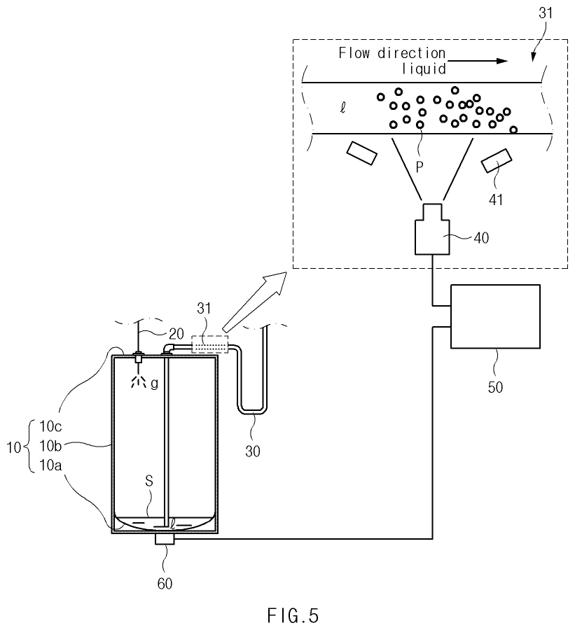

In addition, FIG. 5 is a view illustrating a state in which a vision device 40 and a lighting 41 are disposed to observe the size and number of bubbles through a light transmitting part 31 of a suction tube 30, the ultrasonic generator 60 is attached to the bottom surface 10a of the liquid storage container 10, and each of the vision device and the ultrasonic generator is connected to the same one controller 50.

Referring to the drawings, the apparatus for measuring a remaining amount of liquid within the liquid storage container 10 provided in this embodiment includes the ultrasonic generator 60 attached to an outer surface (bottom surface or circumferential wall) of the liquid storage container in which a liquid is stored to oscillate ultrasonic waves toward the inside of the liquid storage container, an ultrasonic receiver (not shown) that receives the ultrasonic waves returned after being generated from the ultrasonic generator 60, and the controller 50 that estimates the remaining amount of liquid by comparing waveform information of the ultrasonic waves received from the ultrasonic receiver to previously provided reference data. Here, the controller 50 may be the controller 50 provided in the first embodiment or may be provided separately.

That is, in the ultrasonic waves oscillated toward the inside of the liquid storage container 10, carrier wave u1, reflected from a water surface S of an electrolyte 1, and carrier wave u2, reflected from an inner wall (top surface, circumferential, etc.) of the liquid storage container 10 after passing through the water surface S of the electrolyte 1, have amplitudes, phases, frequencies, periods, etc., which are different from each other, and vary in waveform. That is, the ultrasonic waves react differently when passing through a liquid medium and when passing through a gaseous (air) medium, resulting in varying waveform. Thus, a height of the water surface S of the electrolyte may be determined through a difference in waveform of the carrier waves u1 and u2 or a change in characteristic of a carrier wave u3 according to mounted positions of the ultrasonic generator 60.

The ultrasonic receiver may be integrated with the ultrasonic generator 60, and the ultrasonic generator 60 may oscillate ultrasonic waves and receive the returned ultrasonic waves to transmit information of the received ultrasonic waves to the controller 50.

The ultrasonic generator 60 may be attached to a center from the outside of the bottom surface 10a of the liquid storage container 10 as illustrated in FIGS. 3 and 5 or may be attached to the circumferential wall 10b of the liquid storage container 10 as illustrated in FIG. 4.

Furthermore, this embodiment provides a measurement method using the measuring apparatus having the above configuration.

A method for measuring a remaining amount of liquid within a liquid storage container using ultrasonic waves includes a process of closely attaching an ultrasonic generator 60 generating ultrasonic waves to an outer surface of a liquid storage container, a process of oscillating the ultrasonic waves from the ultrasonic generator 60 to the inside of the liquid storage container 10, a process of receiving the ultrasonic waves returned after the oscillation to analyze the waveform of the ultrasonic waves, and a process of comparing the waveform of the ultrasonic waves to previously provided reference data to estimate the remaining amount of liquid.

Here, the ultrasonic receiver may be integrated into the ultrasonic generator, and two or more ultrasonic receivers may be attached to the liquid storage container to further improve estimation accuracy by individually analyzing the waveform of the ultrasonic waves at different points. For example, the ultrasonic generator with which the ultrasonic receiver is integrated may be in close contact with a center at the outside of a bottom surface 10a of the liquid storage container and may also be in close contact with a circumferential wall 10b of the liquid storage container.

The process of estimating the remaining amount using carrier waves of the ultrasonic waves may be performed before a process of discharging the liquid in the liquid storage container to the outside through the suction tube 30 or after a process of estimating the remaining amount of liquid through a size and number of observed bubbles.

That is, the apparatus for measuring the remaining amount using the ultrasonic waves provided in the second embodiment may be installed together with the apparatus for measuring the remaining amount provided in the first embodiment, as illustrated in FIG. 5. In addition, the method of measuring the remaining amount using the ultrasonic waves provided in the second embodiment may be performed simultaneously with the method of measuring the remaining amount provided in the first embodiment or may be performed sequentially with a time difference.

In this case, the controller 50 may be configured to be connected to a vision device 40, an ultrasonic generator 60, and an ultrasonic receiver to receive all of ultrasonic waveform information and bubble information, thereby finally estimating the remaining amount by synthesizing the two pieces of information.

In addition, in some cases, only one of the methods for measuring the remaining amount provided in the first embodiment and the method for measuring the remaining amount provided in the second embodiment may be implemented.

The present disclosure having the above configuration may determine the remaining amount of liquid (electrolyte) in the liquid storage container in real time, and thus, the input and stop time points and an input amount of gas injected into the liquid storage container may be more accurately determined to solve the conventional problem in which the motor and the pump are malfunctioned, and the bubbles are introduced together into the case of the secondary battery.

According to the present disclosure, the remaining amount may be estimated by observing the size and number of bubbles passing through the suction tube so as not to affect the flow speed of the electrolyte and not to cause the physical and/or chemical changes or impacts to the electrolyte. In addition, since there is no need for separate measuring equipment to be introduced into the liquid storage container, the inflow of the foreign substances may be blocked fundamentally.

When observing the bubbles at the light transmitting part, the additional light may be irradiated from the lighting to observe the size and number of bubbles through the more accurate image data.

In the present disclosure, the controller may more quickly estimate the remaining amount of liquid by comparing the size and number of observed bubbles to the previously provided reference data.

Alternatively, the controller may estimate the remaining amount of liquid using the machine learning method that learns by comparing and analyzing the correlation between the size and number of observed bubbles and the actual remaining amount of liquid and estimates the remaining amount of liquid based on the learned data, and thus, even when the physical properties are changed, or the size of the liquid storage container is changed, the remaining amount of liquid may be estimated in consideration of the variables.

Furthermore, in the present disclosure, the remaining amount of electrolyte may be estimated using the ultrasonic carrier wave. Therefore, the remaining amount of electrolyte may be more accurately measured by performing the method for estimating the remaining amount by observing the bubbles.

While the embodiments of the present disclosure have been described with reference to the specific embodiments, it will be apparent to those skilled in the art that various changes and modifications may be made without departing from the spirit and scope of the disclosure as defined in the following claims.

### DESCRIPTION OF THE SYMBOLS

10: Liquid storage container
20: Gas injection tube
30: Suction tube
31: Light transmitting part
40: Vision device
41: Lighting
50: Controller
60: Ultrasonic generator

1. A method for measuring a remaining amount of a liquid within a liquid storage container, comprising:
discharging the liquid within the liquid storage container to the outside through a suction tube inserted into the liquid storage container;
observing a size or a number of bubbles contained in the liquid passing through a light transmitting part via a vision device that emits light toward the light transmitting part of the suction tube; and
estimating the remaining amount of the liquid based on the size and the number of the bubbles observed.

2. The method of claim 1, further comprising injecting a gas into the liquid storage container within a predetermined range after the discharging of the liquid.

3. The method of claim 2, wherein the liquid is an electrolyte for a secondary battery, and
the gas injected into the liquid storage container is nitrogen.

4. The method of claim 2, further comprising, stopping the injection of the gas into the liquid storage container when an estimated remaining amount of the liquid is less than a predetermined remaining amount.

5. The method of claim 1, wherein in the observing of the size or the number of the bubbles, light is emitted from a lighting toward the light transmitting part.

6. The method of claim 1, wherein the estimating of the remaining amount of the liquid is performed via a controller in a machine learning manner in which a correlation between the size and the number of the bubbles observed based on information received from the vision device and an actual amount of liquid remaining is learned to estimate the remaining amount based on the-learned data.

7. The method of claim 1, wherein the estimating of the remaining amount of the liquid is performed via a controller compares the size and the number of the observed bubbles based on information received from the vision device to previously provided reference data.

8. The method of claims 1, further comprising estimating the remaining amount of the liquid using an ultrasonic carrier wave,
wherein the estimating of the remaining amount of the liquid using the ultrasonic carrier wave comprises:
oscillating ultrasonic waves from an ultrasonic generator to the inside of the liquid storage container;
receiving the ultrasonic waves returned after the oscillation so as to analyze a waveform of the ultrasonic waves; and
comparing the waveform of the ultrasonic waves to previously provided reference data to estimate the remaining amount of the liquid.

9. The method of claim 8, wherein the ultrasonic generator is in close contact with a center of an outer surface of a bottom of the liquid storage container or is in close contact with a circumferential wall of the liquid storage container.

10. The method of claim 8, wherein the estimating of the remaining amount of the liquid using the ultrasonic carrier wave is performed before the discharging of the liquid within the liquid storage container to the outside through the suction tube.

11. The method of claim 8, wherein the estimating of the remaining amount of the liquid using the ultrasonic carrier wave is performed after the estimating of the remaining amount of the liquid based on the size and the number of the observed bubbles.

12. An apparatus for measuring a remaining amount of liquid within a liquid storage container, comprising:
a liquid storage container configured to store liquid;
a suction tube connected to the liquid storage container, configured to suction and discharge the liquid, and which is provided with a light transmitting part made of a transparent or translucent material;
a vision device directed toward the light transmitting part; and
a controller configured to receive information about a size and number of bubbles from the vision device so as to estimate the remaining amount of liquid.

13. The apparatus of claim 12, wherein the controller is configured to output information on the size and the number of bubbles and estimation results on a display device.

14. The apparatus of claim 13, further comprising a lighting configured to emit light toward the light transmitting part.

15. The apparatus of claim 13, wherein the light transmitting part is disposed in a predetermined section in the suction tube and is disposed in a section extending in a straight line from outside of the liquid storage container.

16. (canceled)

17. An apparatus for measuring a remaining amount of liquid within a liquid storage container, comprising:
a liquid storage container configured to store liquid;
an ultrasonic generator attached to an outer surface of the liquid storage container and configured to oscillate ultrasonic waves toward an inside of the liquid storage container;
an ultrasonic receiver configured to receive the ultrasonic waves returned after being generated by the ultrasonic generator; and
a controller configured to estimate the remaining amount of the liquid by comparing waveform information of the ultrasonic waves received from the ultrasonic receiver to previously provided reference data.

18. The apparatus of claim 17, wherein the ultrasonic receiver is integrated with the ultrasonic generator, and the ultrasonic generator is configured to oscillate the ultrasonic waves, receive the returned ultrasonic waves, and transmits waveform information of the received ultrasonic waves to the controller.

19. The apparatus of claim 18, wherein the ultrasonic generator is attached to a center of an outer surface of a bottom of the liquid storage container.

20. The apparatus of claim 18, wherein the ultrasonic generator is attached to a circumferential wall of the liquid storage container.
